(19) United States
(12) Patent Application Publication
(10) Pub. No.: US 2012/0174792 A1
(43) Pub. Date: Jul. 12, 2012

(54) PORTABLE AIR TREATMENT APPARATUS INCLUDING AN ANION GENERATOR

(76) Inventor: Chia-Cheng Chang, New Taipei City (TW)

(21) Appl. No.: 12/986,853

(22) Filed: Jan. 7, 2011

(51) Int. Cl. B03C 3/16

(52) U.S. Cl. 96/52

(57) ABSTRACT

A portable air treatment apparatus includes a housing formed with an air intake, a cool air vent, a warm air vent, and a compartment. The compartment is separated into a temperature modification chamber and a containment chamber for containing ionized water. The portable air treatment apparatus further includes a temperature modification device for heating and cooling that is disposed in the temperature modification chamber, and that includes a cool air duct in fluid communication with the cool air vent, and a warm air duct in fluid communication with the warm air vent. The portable air treatment apparatus also includes an anion generator that includes a fogger disposed in the containment chamber. The anion generator further includes a venting pipe in fluid communication with the cool air duct and the warm air duct.

### BACKGROUND OF THE INVENTION

1. Field of the Invention

The invention relates to a portable air treatment apparatus, and more particularly to a portable air treatment apparatus including an anion generator.

2. Description of the Related Art

Taiwan Patent Publication Number 251687 discloses a conventional air-conditioner that lacks additional functionality. As a result, a user of the conventional air-conditioner may be unable to perform other air treatment functions that may provide benefits to a user's health or comfort.

### SUMMARY OF THE INVENTION

An object of the present invention is to provide a portable air treatment apparatus with an anion generator.

Accordingly, a portable air treatment apparatus of the present invention includes a housing formed with an air intake, a cool air vent, a warm air vent, and a compartment. The compartment is separated into a temperature modification chamber and a containment chamber for containing ionized water. The portable air treatment apparatus further includes a temperature modification device for heating and cooling. The temperature modification device is disposed in the temperature modification chamber, and includes a cool air duct in fluid communication with the cool air vent, and a warm air duct in fluid communication with the warm air vent. The portable air treatment apparatus also includes an anion generator that includes a fogger disposed in the containment chamber. The fogger has a motor, an agitator driven by the motor for agitating the water to generate anion-containing vapor, and an impeller driven by the motor. The anion generator further includes a venting pipe in fluid communication with the cool air duct and the warm air duct. The impeller drives the anion-containing vapor out through one of the cool air vent and the warm air vent.

An advantage of this invention includes the inclusion of an anion generating function in the portable air treatment apparatus to improve user comfort.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic perspective view of the preferred embodiment of a portable air treatment apparatus with an anion generator according to the present invention;

FIG. 2 is a fragmentary schematic view illustrating electromagnetic valves for controlling fluid flow through ducts of a venting pipe of the preferred embodiment; and

FIG. 3 is another fragmentary schematic view illustrating cool and warm air venting holes of the preferred embodiment.

### DETAILED DESCRIPTION OF THE PREFERRED EMBODIMENT

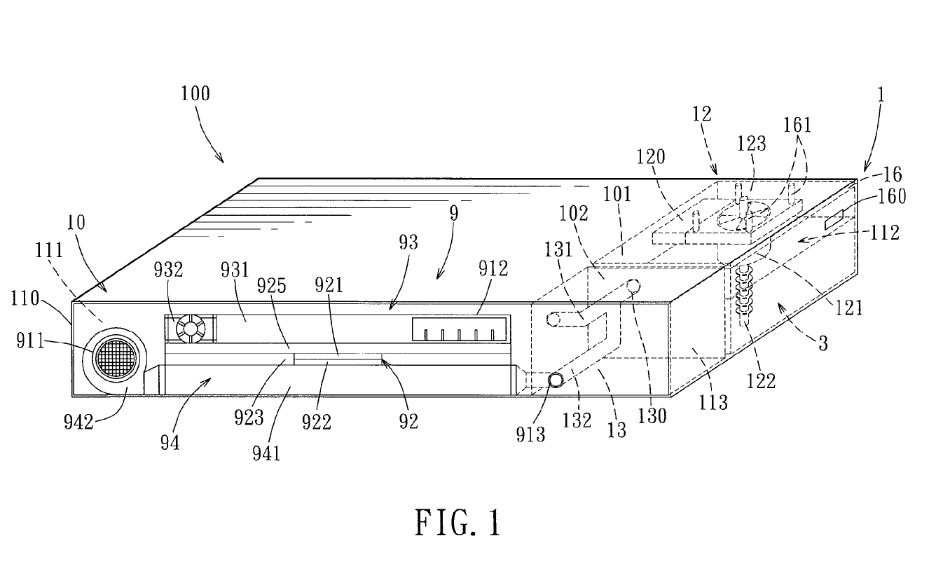

Referring to FIG. 1, the preferred embodiment of a portable air treatment apparatus 100 according to the present invention is shown to include a case 10, a heating and cooling apparatus 9 and an anion generator 1.

The case 10 includes a housing 110, a first partition wall 101 and a second partition wall 102. The housing 110 has a front side formed with an air intake 911, a cool air vent 912 and a warm air vent 913. The first partition wall 101 and the second partition wall 102 partition the inner space confined by the housing 110 into a temperature modification chamber 111, a containment chamber 112, and a pipe chamber 113. The containment chamber 112 is adapted for receiving ionized water 3 containing anions.

The heating and cooling apparatus 9 is disposed in the temperature modification chamber 111, and includes a thermoelectric chip 92, a cool air output component 93 and a warm air output component 94. The thermoelectric chip 92 is a thin-foil type thermoelectric component that includes a cooling interface 921 and a heating interface 922. The thermoelectric chip 92 is mounted fixedly in the housing 110.

The cool air output component 93 is mounted in the housing 110 adjacent to a first side of the thermoelectric chip 92, and has a cool air duct 931. The cool air duct 931 is disposed to abut against the cooling interface 921 of the thermoelectric chip 92, and includes a first end connected to the cool air vent 912 of the housing 110, a second end, and a first fan 932 that is mounted at the second end of the cool air duct 931. The first fan 932 has an intake end in fluid communication with the air intake 911 of the housing 110 for guiding air to flow through the cool air duct 931 to generate cool air that is output from the housing 110 via the cool air vent 912.

The warm air output component 94 is mounted in the housing 110 adjacent to a second side of the thermoelectric chip 92 opposite the first side, and has a warm air duct 941. The warm air duct 941 is disposed to abut against the heating interface 922 of the thermoelectric chip 92, and includes a first end connected to the warm air vent 913 of the housing 110, a second end, and a second fan 942 that is mounted at the second end of the warm air duct 941. The second fan 942 has an intake end in fluid communication with the air intake 911 of the housing 110 for guiding air to flow through the warm air duct 941 to generate warm air that is output from the housing 110 via the warm air vent 913.

The heating and cooling apparatus 9 further includes an insulating material 923 that surrounds the thermoelectric chip 92. The heating interface 922 is provided with a first heat conducting material formed as a heat-collecting plate (not shown) to abut against the warm air duct 941. The cooling interface 921 is provided with a second heat conducting material 925 to abut against the cool air duct 931. Accordingly, the heat conducting effect for heating and cooling may be enhanced.

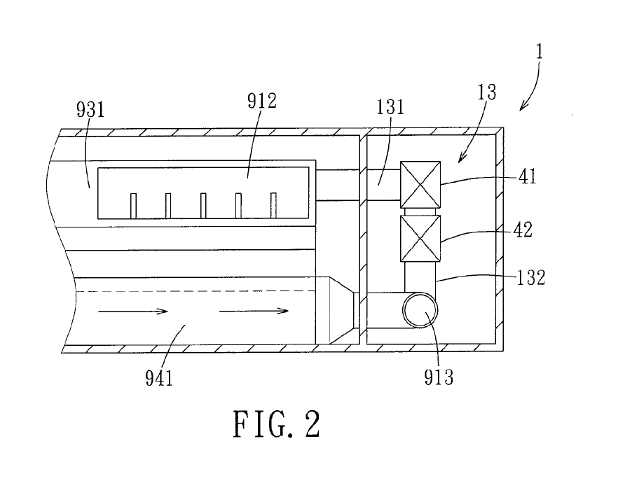

Referring to FIGS. 1 and 2, the warm air duct 941 can be configured to have a plate with a lateral side formed with a plurality of heat-dissipating fins (not shown). The plate is disposed adjacent to the heating interface 922 of the thermoelectric chip 92, and the plurality of heat-dissipating fins are disposed parallel to the flow direction of air driven by the second fan 942.

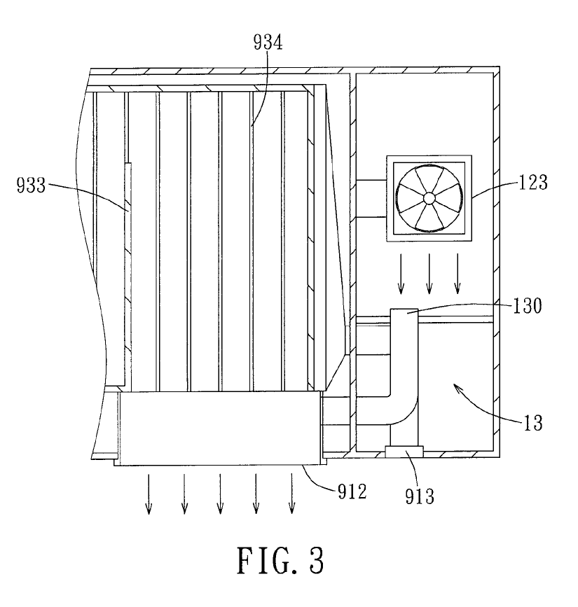

Referring to FIGS. 2 and 3, the cool air duct 931 includes a plurality of partition plates 933 to form a meandering cool air passage in the cool air duct 931. The cool air duct 931 also includes a plurality of fins 934 disposed in the inner lateral side proximate to the thermoelectric chip 92 to increase the conducting effect for the cool air. The fins 934 are half the height of the cool air duct 931.

As shown in FIG. 1, the anion generator 1 includes a fogger 12, and a venting pipe 13 having a pipe hole 130. The fogger 12 is disposed in the containment chamber 112 and includes a control module 120, a motor 121 controlled by the control module 120, an agitator 122 driven by the motor 121 for stirring the ionized water 3 to generate anion-containing vapor, and an impeller 123 driven by the motor 121.

Preferably, the impeller 123 is disposed above the motor 121, and the agitator 122 includes a shaft with a spirally extending flange and is disposed below the motor 121. The case 10 includes a cover 16 disposed above the containment chamber 112, and a plurality of fasteners 161 for fixing the impeller 123 to the bottom side of the cover 16. The motor 121, the agitator 122, and the impeller 123 are fixed together to allow the ionized water 3 to be added to the containment chamber 112 when the cover 16 is removed. The housing 110 includes a water discharge hole 160 formed in a lateral side proximate to the containment chamber 112. Excess ionized water 3 is discharged when the liquid level reaches the water discharge hole 160 to prevent the motor 121 and the control module 120 from being damaged and to prevent ionized water 3 from flowing through the pipe hole 130 into the venting pipe 13.

Referring to FIGS. 2 and 3, the venting pipe 13 is connected to the cool air duct 931 and the warm air duct 941 for outputting the anion-containing vapor through the cool air vent 912 and the warm air vent 913.

Preferably, the venting pipe 13 includes a first duct 131 connected to and in fluid communication with the cool air duct 931 and a second duct 132 connected to and in fluid communication with the warm air duct 941. The anion generator 1 further includes a first electromagnetic valve 41 coupled to and controlled by the control module 120 to control fluid flow through the first duct 131, and a second electromagnetic valve 42 coupled to and controlled by the control module 120 to control fluid flow through the second duct 132.

Referring to FIG. 1, when the heating and cooling apparatus 9 of the portable air treatment apparatus 100 operates, the thermoelectric chip 92 is electrically powered to reduce the temperature of the cooling interface 921, which cools air in the cool air duct 931 by cooling the second heat conducting material 925. The first fan 932 is also activated to move air cooled by the cool air duct 931 out of the case 10 through the cool air vent 912 to the external environment. When the heating function of the heating and cooling apparatus 9 operates, the temperature of the heating interface 922 is increased to heat the air in the warm air duct 941 through the heat-collecting place (not shown). Warm air can then flow out of the case 10 to the external environment through the warm air vent 913.

Referring to FIGS. 1 to 3, when the anion generating function of the heating and cooling apparatus 9 is used, the control module 120 operates the motor 121, which causes the agitator 122 to stir the ionized water 3 and causes the air above the ionized water 3 to carry anions. The motor 121 also drives the impeller 123 that blows the air containing anions through the venting pipe 13 and out of the housing 110 through the cool air vent 912 or the warm air vent 913.

At the same time, the anion-containing vapor may be heated or cooled. For the cooling function, the first electromagnetic valve 41 is activated to permit fluid flow through the first duct 131, and the second electromagnetic valve 42 is deactivated to block fluid flow through the second duct 132. For the heating function, the second electromagnetic valve 42 is activated to permit fluid flow through the second duct 132, and the first electromagnetic valve 41 is deactivated to block fluid flow through the first duct 131. In this way, the anion generating effect can be provided with both heating and cooling.

Preferably, the portable air treatment apparatus 100 further includes a battery seat (not shown) mounted in the case 10. The battery seat includes a battery lid that may be lifted to permit insertion of a battery in the battery seat. The battery provides power for the anion generator 1, the thermoelectric chip 92, the first fan 932 and the second fan 942. The case 10 may also be mounted with or connected externally to a solar cell (not shown) for providing power. The case 10 may also include a power cord (not shown) for connecting the heating and cooling apparatus 9 to an external power source in a vehicle or a building for providing power for the anion generator 1, the thermoelectric chip 92, the first fan 932 and the second fan 942.

In summary, by adding the anion generator 1 to the portable air treatment apparatus 100, a function of anion generation is provided to make the portable air treatment apparatus 100 more comfortable for users.

While the present invention has been described in connection with what is considered the most practical and preferred embodiment, it is understood that this invention is not limited to the disclosed embodiment but is intended to cover various arrangements included within the spirit and scope of the broadest interpretation to encompass all such modifications and equivalent arrangements.

What is claimed is:

1. A portable air treatment apparatus comprising:
a housing formed with an air intake, a cool air vent, a warm air vent, and a compartment, said compartment being separated into a temperature modification chamber and a containment chamber for containing ionized water;
a temperature modification device for heating and cooling, said temperature modification device being disposed in said temperature modification chamber, and including a cool air duct in fluid communication with said cool air vent, and a warm air duct in fluid communication with said warm air vent; and
an anion generator that includes
a fogger disposed in said containment chamber, and having a motor, an agitator driven by said motor for agitating the water to generate anion-containing vapor, and an impeller driven by said motor, and
a venting pipe in fluid communication with said cool air duct and said warm air duct, said impeller driving the anion-containing vapor out through one of said cool air vent and said warm air vent.

2. The portable air treatment apparatus as claimed in claim 1, wherein said venting pipe includes a first duct in fluid communication with said cool air duct, and a second duct in fluid communication with said warm air duct, and
said anion generator further includes
a control module,
a first electromagnetic valve coupled to and controlled by said control module to control fluid flow through said first duct, and
a second electromagnetic valve coupled to and controlled by said control module to control fluid flow through said second duct.

3. The portable air treatment apparatus as claimed in claim 2, wherein said temperature modification device further includes:
a thermoelectric chip mounted in said housing, and having a first side, a second side opposite said first side, a cooling interface, and a heating interface;
a cool air output component mounted in said housing adjacent to said first side of said thermoelectric chip, and having said cool air duct, wherein said cool air duct is disposed to abut against said cooling interface of said thermoelectric chip, and includes
a first end connected to said cool air vent of said housing,
a second end, and
a first fan that is mounted at said second end of said cool air duct, and that has an intake end in fluid communication with said air intake of said housing for guiding air to flow through said cool air duct to generate cool air that is output from said housing via said cool air vent; and
a warm air output component mounted in said housing adjacent to said second side of said thermoelectric chip, and having said warm air duct, wherein said warm air duct is disposed to abut against said heating interface of said thermoelectric chip, and includes
a first end connected to said warm air vent of said housing,
a second end, and
a second fan that is mounted at said second end of said warm air duct and that has an intake end in fluid communication with said air intake of said housing for guiding air to flow through said warm air duct to generate warm air that is output from said housing via said warm air vent.

4. The portable air treatment apparatus as claimed in claim 3, further comprising:
an insulating material that surrounds said thermoelectric chip,
wherein said heating interface is provided with a a first heat conducting material to abut against said warm air duct, and
wherein said cooling interface is provided with a second heat conducting material to abut against said cooling interface and said cool air duct.

5. The portable air treatment apparatus as claimed in claim 4, wherein said first heat conducting material is a heat-collecting plate.

6. The portable air treatment apparatus as claimed in claim 3, further comprising a battery seat mounted in said housing, and configured to receive a battery for providing power to said anion generator, said thermoelectric chip, said first fan and said second fan.

7. The portable air treatment apparatus as claimed in claim 3, further comprising a solar cell mounted to said housing for providing electric power to said anion generator, said thermoelectric chip, said first fan, and said second fan.

8. The portable air treatment apparatus as claimed in claim 3, further comprising a power cord that extends outwardly from said housing for providing electric power to said anion generator, said thermoelectric chip, said first fan, and said second fan.

9. The portable air treatment apparatus as claimed in claim 1, wherein said agitator includes a shaft having a spirally extending flange.
